(19) United States
(12) Patent Application Publication
(10) Pub. No.: US 2012/0129414 A1
(43) Pub. Date: May 24, 2012

(54) THERMOSETTING RESIN COMPOSITION AND PREPREG OR LAMINATE USING THE SAME

(76) Inventors: Chung-Hao CHANG, Taoyuan Hsien (TW); Hsiu-Lien Wu, Taoyuan Hsien (TW); Han-Shiang Huag, Taoyuan Hsien (TW); Chia-Hsiu Yeh, Taoyuan Hsien (TW)

(21) Appl. No.: 12/954,345

(22) Filed: Nov. 24, 2010

(51) Int. Cl. B32B 5/02; C08K 3/22; C08K 3/36; B32B 27/38; C08K 3/28; C08K 3/38; C08K 3/34; C08L 63/00; C08K 7/18

(52) U.S. Cl. 442/175; 525/117; 525/403; 525/186; 525/190; 525/418; 524/437; 524/436; 524/430; 524/493; 523/223; 524/428; 524/404; 524/443; 428/418; 442/59

(57) ABSTRACT

A thermosetting resin composition and a prepreg or laminate using the same are provided. The thermosetting resin composition includes an epoxy resin and a curing agent, in which the curing agent is a dual-curing agent system formed with a multi-functional aromatic polyester curing agent in combination with a phenolphthalein benzoxazine phenol aldehyde or a poly(styrene-co-maleic anhydride). An organic or inorganic fiber reinforced material is impregnated with the thermosetting resin composition to form a prepreg, and the prepreg is bonded to a substrate with a metal foil disposed thereon, to form a laminate.

### BACKGROUND OF THE INVENTION

1. Field of Invention

The present invention relates to a flame retardant thermosetting epoxy resin composition having a low dielectric constant and a low dissipation factor (or referred to as dielectric tangent or dielectric loss), which is capable of being widely used in prepreg structures, printed circuit laminates, build-up bonding resin (resin coated thin core), adhesives, package materials, and FRP products, and particularly used for preparing printed circuit laminates and build-up bonding resin (resin coated thin core).

2. Related Art

Due to excellent electrical insulation, mechanical properties, and adhesion properties, epoxy resins are widely used in the field of electric devices and electronic components, such as varnishes for printed circuit boards (varnish for copper clad laminates), semiconductor package materials (epoxy encapsulant for semiconductors), high-density build-up bonding resin (resin coated thin core for HDI application) and solder masks. Generally, a curing agent used in combination with the epoxy resin is an amine curing agent such as dicyandiamide, a phenol novolac curing agent, and an anhydride curing agent.

The use of electric devices and electronic components is developing towards increased signal transmission quality and low loss of signal transmission, and there are requirements for cloudy computing and green materials. Therefore, as for material development, properties such as low dielectric constant and low dissipation factor, and being free of halogen and flame retardant are required. Currently, a cured material formed with the epoxy resin in combination with the curing agent has high-polarity hydroxyl group, and thus the dissipation factor (dielectric tangent or dielectric loss) cannot be easily lowered. Moreover, a bromide (e.g. tetra-bromine-bis-phenol A, TBBPA) or a brominated epoxy resin needs to be added into the composition, so as to achieve the flame retardant property (94-V0), and thus the properties of being free of halogen and flame retardant cannot be achieved. Therefore, how to develop an environmental halogen-free material having a low dielectric constant and a low dissipation factor has become a quite important issue.

As for curing agents that will generate no hydroxyl group during curing process of the epoxy resin, in Japanese Patent Publication No. 1993-51517 of Hitachi Chemical Co., Ltd., it is disclosed that a cured material having high cross-linked density (Tg=210-290° C. by DMA) may be produced with an aromatic multi-functional polyester as curing agent, and thus meeting the requirement of high-thermal resistant insulating material used in the field of electronic components or electric devices. However, the cured material has unreacted hydroxyl or carboxyl groups, and thus the dissipation factor is increased, and the cured material has no flame retardancy (cannot reach the grade of UL 94-V0). In Japanese Patent Publication No. 2002-12650 of Dainippon Ink Co., Ltd., by using an aromatic polyester curing agent obtained by reacting naphthalenedicarboxylic acid and α-naphthol, a cured material of the epoxy resin has low dissipation factor; however, the cured material also has no flame retardancy, and the terminal group is not cross-linked during curing, and thus the thermal resistance is poor. On the other hand, in U.S. Pat. No. 5,945,222 of Hitachi Chemical Co., Ltd., it is disclosed that when using a thermal setting resin containing dihydrobenzoxazine rings and a novolac phenolic resin as curing agent, the epoxy resin is cured rapidly, and thus a cured material having good mechanical property and having flame retardancy (94-V0) is obtained; however, in the cured material, many hydroxyl groups are generated due to the novolac phenolic resin used in combination, and thus the dielectric constant and the dissipation factor cannot be effectively lowered. Moreover, in U.S. Pat. No. 6,534,181, it is disclosed that reaction of an epoxy resin with poly(styrene-co-maleic anhydride) in combination with a multifunctional amine cross-linking agent can be used in a high-speed and low-loss circuit board; however, it is not disclosed that whether the use of a phosphorous epoxy resin can achieve the flame retardant grade (94-V0) and whether the functions of low dielectric constant and low dissipation factor of the original design are changed.

### SUMMARY OF THE INVENTION

The present invention is directed to a halogen-free thermosetting epoxy resin composition having a low dielectric constant and a low dissipation factor, and a prepreg structure or laminate using the same.

In order to achieve the objectives above, the present invention provides a thermosetting resin composition, and a prepreg structure or laminate using the same. The thermosetting resin composition includes an epoxy resin and a curing agent, in which the curing agent is a dual-curing agent system formed with a multi-functional aromatic polyester curing agent in combination with a phenolphthalein benzoxazine phenol aldehyde or a poly(styrene-co-maleic anhydride). An organic or inorganic woven or non-woven fiber reinforced material is impregnated with the thermosetting resin composition, to form a prepreg, and the prepreg is bonded to a substrate with a metal foil disposed thereon, to form a laminate.

In implementation, the multi-functional aromatic polyester curing agent is formed by reacting an aromatic polyvalent carboxyl residue having an aryloxycarbonyl group on an end the molecule chain and an aromatic polyvalent hydroxyl compound, and has an ester equivalent weight (EEW) of 180-500. The phenolphthalein benzoxazine phenol aldehyde has an —OH value of 200-700, and a nitrogen content of 4-20 wt %. The poly(styrene-co-maleic anhydride) has an acid value of 100-600.

In implementation, the epoxy resin is one of a phosphorus-containing epoxy resin, a nitrogen-containing epoxy resin, and a bis-phenol F epoxy resin, or a combination thereof. The phosphorus-containing epoxy resin is a modified epoxy resin such as DOPO-PNE, DOPO-CNE or DOPO-HQ, and has a phosphorus content of 2-10 wt % and an EEW of 250-800. The nitrogen-containing epoxy resin is one of a N,N-diglycidyl epoxy resin, an epoxy resin having an oxazolidone ring, or a polyamide-imide-epoxy resin (PAI-epoxy), and has a nitrogen content of 5-20 wt % and an EEW of 100-1000; and the bis-phenol F epoxy resin has an EEW of 150-1000.

In implementation, a curing catalyst is further added to the thermosetting resin composition, such that the thermosetting resin composition contains 10-90 wt % of an epoxy resin, 90-10 wt % of a dual-curing agent system, and 0.01-5 wt % of a curing catalyst. The dual-curing agent system contains 20-95 wt % of a multi-functional aromatic polyester curing agent and 5-80 wt % of phenolphthalein benzoxazine phenol aldehyde; or the dual-curing agent system contains 20-95 wt % of a multi-functional aromatic polyester curing agent and 5-80 wt % of poly(styrene-co-maleic anhydride). The curing catalyst is one of an imidazole compound, an organophosphorus compound, an organophosphate compound, a phosphate salt, a trialkylamine, 4-(dimethylamino) pyridine, a quaternary ammonium salt, and a urea compound.

In implementation, a solvent is further used to dissolve the thermosetting resin composition into a varnish-like composition. The solvent may be one of an amide solvent (N-methylpyrrolidone, N-methylformamide, N,N-dimethylformamide, and N,N-dimethylacetamide), a ketone solvent (acetone, methyl ethyl ketone, methyl isobutyl ketone, and cyclohexanone), an ether solvent, an aromatic hydrocarbon solvent, and a glycol monoether.

In implementation, inorganic filler is further added to the thermosetting resin composition, which accounts for 1 to 30 wt % of the composition, is one of alumina hydroxide, aluminium oxide hydroxide, magnesium hydroxide, silica, spherical and crushed alumina, and has an average particle size in a range of 0.01 μm to 20 μm.

In implementation, a high thermal conductive inorganic filler is further added to the thermosetting resin composition, which accounts for 10 to 80 wt % of the composition, is one of hexagonal and spherical aluminum nitride, hexagonal and spherical boron nitride, spherical alumina, crushed alumina, silicon carbide, and graphite. The silicon carbide includes hexagonal α-silicon carbide and cubic β-silicon carbide. Moreover, the high thermal conductive inorganic filler has an average particle size in a range of 0.01 μm to 20 μm.

In implementation, the substrate of the laminate is formed of an organic or inorganic fiber reinforced material, for being impregnated with the thermosetting resin composition thereon.

In order to make the present invention understood more clearly, the present invention is described in detail with reference to an embodiment hereinafter.

### BRIEF DESCRIPTION OF THE DRAWINGS

No drawings.

### DETAILED DESCRIPTION OF THE INVENTION

The thermosetting epoxy resin composition of the present invention mainly contains an epoxy resin and a curing agent.

The epoxy resin is one of a phosphorus-containing epoxy resin, a nitrogen-containing epoxy resin, and a bis-phenol F epoxy resin, or a combination thereof. The phosphorus-containing epoxy resin is a modified epoxy resin such as DOPO-PNE, DOPO-CNE or DOPO-HQ, and has a phosphorus content of 2-10 wt %, an EEW of 250-800, and has a structure as shown below:

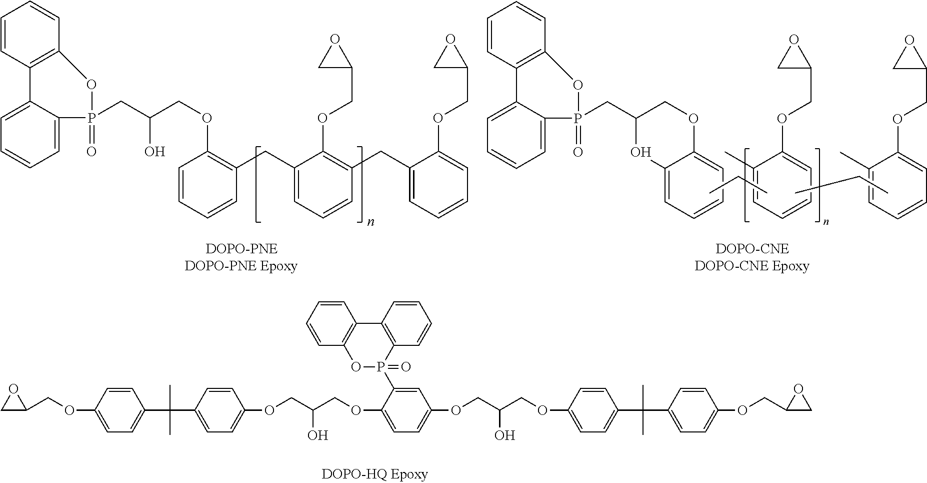

in which n=0.5-10. Preferably, the phosphorus content is 3-7 wt %, and the EEW is 300-500.

The nitrogen-containing epoxy resin is one of a N,N-Diglycidyl epoxy resin, an epoxy resin having an oxazolidone ring, and a polyamide-imide-epoxy resin (PAI-epoxy), and has a nitrogen content of 5-20 wt % and an EEW of 100-1000. Preferably, the nitrogen content is 6-10 wt % and the EEW is 110-700.

The bis-phenol F epoxy resin has an epoxy equivalent of 150-1000, and preferably 160-300.

The curing agent is a dual-curing agent system formed by (1) ring-opening cross-linking a multi-functional aromatic polyester curing agent and a phenolphthalein benzoxazine phenol aldehyde curing agent with epoxy after ring opening reaction, or by (2) ring-opening cross-linking a multi-functional aromatic polyester curing agent and a poly(styrene-co-maleic anhydride) curing agent with epoxy. The formed curing agent has less unreacted hydroxyl or carboxyl group, and is cross-linked with the phosphorus- and nitrogen-containing bi(multi)-functional epoxy resin to produce a cured flame retardant epoxy resin. The curing agent of (1) contains 20-95 wt % of a multi-functional aromatic polyester curing agent, which is formed with an aromatic polyvalent carboxyl residue having an aryloxycarbonyl group at an end of the molecule chain and an aromatic polyvalent hydroxyl compound, and 5-80 wt % of a phenolphthalein benzoxazine phenol aldehyde curing agent; and the curing agent of (2) contains 20-95 wt % of a multi-functional aromatic polyester curing agent and 5-80 wt % of poly(styrene-co-maleic anhydride) curing agent.

a: The multi-functional aromatic polyester curing agent has an EEW of 180-500 and a structure as shown below:

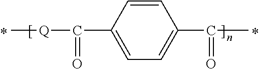

in which Q has a formula below, X is —CH₂, —C(CH₃)₂, or —SO₂, and n is an integer of 1-10.

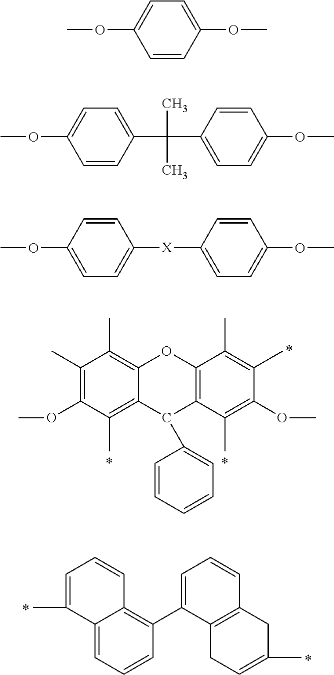

b: The phenolphthalein benzoxazine phenol aldehyde curing agent has an —OH value of 200-700, a nitrogen content of 4-20 wt % and preferably 5-10 wt %, a hydroxyl equivalent (—OH value) of 200-400, and a structure as shown below:

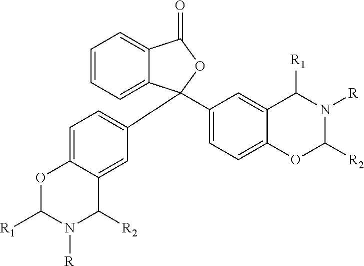

in which R is allyl, a unsubstituted or substituted phenyl, a unsubstituted or substituted C₁-C₈ alkyl, or a unsubstituted or substituted C₃-C₈ cycloalkyl. R₁ and R₂ is hydrogen, an aromatic compound, or an aliphatic compound.

c: The poly(styrene-co-maleic anhydride) (SMA) curing agent has an acid value of 100-600, and preferably 300-500, and a structure as shown below:

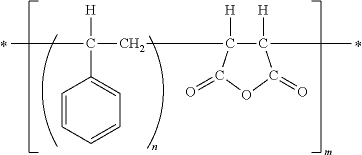

in which m is an integer of 2-12, n is an integer of 1-8, and preferably m/n=3-5.

Furthermore, a curing catalyst is further added in the thermosetting resin composition of the present invention, such that the thermosetting resin composition contains 10-90 wt % of an epoxy resin, 90-10 wt % of a dual-curing agent system, and 0.01-5 wt % of a curing catalyst. The dual-curing agent system contains 20-95 wt % of a multi-functional aromatic polyester curing agent and 5-80 wt % of phenolphthalein benzoxazine phenol aldehyde, or the dual-curing agent system contains 20-95 wt % of a multi-functional aromatic polyester curing agent and 5-80 wt % of poly(styrene-co-maleic anhydride). The curing catalyst is one of an imidazole compound, an organophosphorus compound, an organophosphate compound, a phosphate salt, a trialkylamine, 4-(dimethylamino)pyridine, a quaternary ammonium salt, and an urea compound. If the formulation content of the curing catalyst is lower than 0.01 wt %, the curing rate is slow, and if the content is higher than 5 wt %, auto polymerization (homogeneous polymerization) of the epoxy resin occurs, thus impacting the curing reaction of the multi-functional aromatic polyester curing agent and the phenolphthalein benzoxazine phenol aldehyde curing agent with the epoxy resin.

Moreover, in order to formulate an epoxy resin composition for printed circuit boards, build-up binding agents and carbon fiber reinforced plastics (CFRP), a solvent is used to dissolve the epoxy resin composition into a varnish-like composition to a content of 10-70 wt %, and preferably 15-65 wt %. The solvent is one of an amide solvent (N-methylpyrrolidone, N-methylformamide, N,N-dimethylformamide, and N,N-dimethylacetamide), a ketone solvent (acetone, methyl ethyl ketone, methyl isobutyl ketone, and cyclohexanone), an ether solvent, an aromatic hydrocarbon solvent, and a glycol monoether.

Furthermore, an inorganic filler may be added into the composition of the thermosetting epoxy resin composition of the present invention, the curing catalyst, and the solvent according to the use. The inorganic filler accounts for 1 to 30 wt % of the composition, includes one of alumina hydroxide [Al(OH)₃], aluminium oxide hydroxide [AlOOH], magnesium hydroxide [Mg(OH)₂], silica [SiO₂], and spherical and crused alumina [Al₂O₃], and has an average particle size in a range of 0.01 μm to 20 μm.

Furthermore, a high thermal conductive inorganic filler may be further added to the composition of the thermosetting epoxy resin composition of the present invention, the curing catalyst, and the solvent, to fabricate a heat sink insulating adhesive layer or a substrate having a high thermal conductivity and a low dissipation factor. The inorganic filler accounts for 10 to 80 wt %, and preferably 40 to 65 wt % of the composition, may be one of hexagonal and spherical aluminum nitride [AlN], hexagonal and spherical boron nitride [BN], spherical and crushed alumina [Al₂O₃], silicon carbide [SiC], and graphite, and has an average particle size in a range of 0.01 μm to 20 μm.

Referring to Table 1 below, Table 1 shows a formulation process for forming an epoxy resin varnish according to Embodiment 1. A multi-functional aromatic polyester curing agent, phenolphthalein benzoxazine phenol aldehyde or poly(styrene-co-maleic anhydride) in solid state were added to a mixed solvent of methyl ethyl ketone (MEK), cyclohexanone, and propylene glycol methyl ether acetate (PMA), stirred and slowly heated to 70° C., till a dual-curing agent mixture appeared transparent and clear. Next, the mixture was cooled to 25-30° C., and then a curing catalyst, and a phosphorous-containing and a nitrogen-containing epoxy resins were sequentially added and uniformly stirred, to prepare an epoxy resin varnish. The formed varnish has a viscosity of about 15±5 s (@ 25° C. by Cup #3) and a gel time of about 250±20 s (@ 170° C. by hot platen)

TABLE 1

| | | Composition 1 | | Composition 2 | | Composition 3 | |
|---|---|---|---|---|---|---|---|
| | | Ester group | | Ester group | | Ester group | |
| | | (Acid | | (Acid | | (Acid | |
| | | value, | Amount | value, | Amount | value, | Amount |
| Ingredient | | Hydroxyl) | (g) | Hydroxyl) | (g) | Hydroxyl) | (g) |
| Curing | Multi-functional aromatic | 220 | 200 | 220 | 200 | 220 | 200 |
| Agent | polyester curing agent | | | | | | |
| | Phenolphthalein benzoxazine | 290 | 800 | 290 | 800 | 290 | 800 |
| | phenol aldehyde | | | | | | |
| | Poly(styrene-co-maleic | 215 | 0 | 215 | 0 | 215 | 0 |
| | anhydride) | | | | | | |
| Solvent | Methyl vinyl ketone | — | 38 | — | 38 | — | 38 |
| | Cyclohexanone | — | 318 | — | 318 | — | 318 |
| | Propylene glycol methyl | — | 182 | — | 182 | — | 182 |
| | ether acetate | | | | | | |
| | | | Amount | | Amount | | Amount |
| | | EEW | (g) | EEW | (g) | EEW | (g) |
| Epoxy | Phosphorus-containing | 375 | 688 | 375 | 688 | 375 | 688 |
| Resin | epoxy resin | | | | | | |
| | Nitrogen-containing epoxy | 170 | 187 | 170 | 0 | 170 | 0 |
| | resin (1) | | | | | | |
| | Nitrogen-containing epoxy | 350 | 0 | 350 | 385 | 350 | 0 |
| | resin (2) | | | | | | |
| | Nitrogen-containing epoxy | 650 | 0 | 650 | 0 | 650 | 715 |
| | resin (3) | | | | | | |
| | Bis-phenol F epoxy resin | 170 | 125 | 170 | 125 | 170 | 125 |
| Solvent | Cyclohexanone | — | 323 | — | 387 | — | 494 |
| | Propylene glycol methyl | — | 125 | — | 258 | — | 329 |
| | ether acetate | | | | | | |
| Catalyst | 4-(dimethylamino)pyridine | — | 1 | — | 1 | — | 1 |
| | | Composition 4 | | Composition 5 | | Composition 6 | |
| | | Ester group | | Ester group | | Ester group | |
| | | (Acid | | (Acid | | (Acid | |
| | | value, | Amount | value, | Amount | value, | Amount |
| Ingredient | | Hydroxyl) | (g) | Hydroxyl) | (g) | Hydroxyl) | (g) |
| Curing | Multi-functional aromatic | 220 | 950 | 220 | 950 | 220 | 950 |
| Agent | polyester curing agent | | | | | | |
| | Phenolphthalein benzoxazine | 290 | 50 | 290 | 50 | 290 | 50 |
| | phenol aldehyde | | | | | | |
| | Poly(styrene-co-maleic | 215 | 0 | 215 | 0 | 215 | 0 |
| | anhydride) | | | | | | |
| Solvent | Methyl vinyl ketone | — | 38 | — | 38 | — | 38 |
| | Cyclohexanone | — | 318 | — | 318 | — | 318 |
| | Propylene glycol methyl | — | 182 | — | 182 | — | 182 |
| | ether acetate | | | | | | |
| | | | Amount | | Amount | | Amount |
| | | EEW | (g) | EEW | (g) | EEW | (g) |
| Epoxy | Phosphorus-containing | 375 | 842 | 375 | 842 | 375 | 842 |
| resin | epoxy resin | | | | | | |
| | Nitrogen-containing epoxy | 170 | 229 | 170 | 0 | 170 | 0 |
| | resin (1) | | | | | | |
| | Nitrogen-containing epoxy | 350 | 0 | 350 | 472 | 350 | 0 |
| | resin (2) | | | | | | |
| | Nitrogen-containing epoxy | 650 | 0 | 650 | 0 | 650 | 876 |
| | resin (3) | | | | | | |
| | Bis-phenol F epoxy resin | 170 | 1153 | 170 | 153 | 170 | 153 |
| Solvent | Cyclohexanone | — | 395 | — | 474 | — | 604 |
| | Propylene glycol methyl | — | 264 | — | 316 | — | 403 |
| | ether acetate | | | | | | |
| Catalyst | 4-(dimethylamino)pyridine | — | 1 | — | 1 | — | 1 |
| | | Composition 7 | | Composition 8 | | Composition 9 | |
| | | Ester group | | Ester group | | Ester group | |
| | | (Acid | | (Acid | | (Acid | |
| | | value, | Amount | value, | Amount | value, | Amount |
| Ingredient | | Hydroxyl) | (g) | Hydroxyl) | (g) | Hydroxyl) | (g) |
| Curing | Multi-functional aromatic | 220 | 200 | 220 | 200 | 220 | 200 |
| agent | polyester curing agent | | | | | | |
| | Phenolphthalein benzoxazine | 290 | 0 | 290 | 0 | 290 | 0 |
| | phenol aldehyde | | | | | | |
| | Poly(styrene-co-maleic | 215 | 800 | 215 | 800 | 215 | 800 |
| | anhydride) | | | | | | |
| Solvent | Methyl vinyl ketone | — | 38 | — | 38 | — | 38 |
| | Cyclohexanone | — | 318 | — | 318 | — | 318 |
| | Propylene glycol methyl | — | 182 | — | 182 | — | 182 |
| | ether acetate | | | | | | |
| | | | Amount | | Amount | | Amount |
| | | EEW | (g) | EEW | (g) | EEW | (g) |
| Epoxy | Phosphorus-containing | 375 | 868 | 375 | 868 | 375 | 868 |
| resin | epoxy resin | | | | | | |
| | Nitrogen-containing epoxy | 170 | 236 | 170 | 0 | 170 | 0 |
| | resin (1) | | | | | | |
| | Nitrogen-containing epoxy | 350 | 0 | 350 | 486 | 350 | 0 |
| | resin (2) | | | | | | |
| | Nitrogen-containing epoxy | 650 | 0 | 650 | 0 | 650 | 903 |
| | resin (3) | | | | | | |
| | Bis-phenol F epoxy resin | 170 | 157 | 170 | 157 | 170 | 157 |
| Solvent | Cyclohexanone | — | 408 | — | 488 | — | 623 |
| | Propylene glycol methyl | — | 272 | — | 326 | — | 415 |
| | ether acetate | | | | | | |
| Catalyst | 4-(dimethylamino)pyridine | — | 1 | — | 1 | — | 1 |
| | | Composition 10 | | Composition 11 | | Composition 12 | |
| | | Ester group | | Ester group | | Ester group | |
| | | (Acid | | (Acid | | (Acid | |
| | | value, | Amount | value, | Amount | value, | Amount |
| Ingredient | | Hydroxyl) | (g) | Hydroxyl) | (g) | Hydroxyl) | (g) |
| Curing | Multi-functional aromatic | 220 | 950 | 220 | 950 | 220 | 950 |
| Agent | polyester curing agent | | | | | | |
| | Phenolphthalein benzoxazine | 290 | 0 | 290 | 0 | 290 | 50 |
| | phenol aldehyde | | | | | | |
| | Poly(styrene-co-maleic | 215 | 50 | 215 | 50 | | 0 |
| | anhydride) | | | | | | |
| Solvent | Methyl vinyl ketone | — | 38 | — | 38 | — | 38 |
| | Cyclohexanone | — | 318 | — | 318 | — | 318 |
| | Propylene glycol methyl | — | 182 | — | 182 | — | 182 |
| | ether acetate | | | | | | |
| | | | Amount | | Amount | | Amount |
| | | EEW | (g) | EEW | (g) | EEW | (g) |
| Epoxy | Phosphorus-containing | 375 | 853 | 375 | 853 | 375 | 853 |
| Resin | epoxy resin | | | | | | |
| | Nitrogen-containing epoxy | 170 | 232 | 170 | 0 | 170 | 0 |
| | resin (1) | | | | | | |
| | Nitrogen-containing epoxy | 350 | 0 | 350 | 478 | 350 | 0 |
| | resin (2) | | | | | | |
| | Nitrogen-containing epoxy | 650 | 0 | 650 | 0 | 650 | 887 |
| | resin (3) | | | | | | |
| | Bis-phenol F epoxy resin | 170 | 155 | 170 | 155 | 170 | 155 |
| Solvent | Cyclohexanone | — | 401 | — | 480 | — | 612 |
| | Propylene glycol methyl | — | 267 | — | 320 | — | 408 |
| | ether acetate | | | | | | |
| Catalyst | 4-(dimethylamino)pyridine | — | 1 | — | 1 | — | 1 |

### Embodiment 2: Fiberglass Reinforced Prepreg

A prepreg was prepared with the epoxy resin varnish formulated in Embodiment 1 according to Table 1. A woven fiberglass reinforced material (E-glass of 7628, 210 g/m²) was impregnated with the varnish, removed of excessive resin by passing through a gap with a distance of typically about 0.015″ between two rollers, and passed through a tunnel oven at 170° C. for about 5-6 min. After cooling, the resin content was tested, which could be adjusted by adjusting the gap between the rollers. The curing degree of the organic or inorganic woven or non-woven fiber reinforced prepreg was measured by melt viscosity (CAP2000 @ 145° C.) or gel time (@ 171° C.), and the melting viscosity was about 200-400 cp and the gel time was about 100-140 s.

### Embodiment 3: Laminate (in this Embodiment, Preparation of a Copper Foil Substrate was Taken as an Example)

A copper foil substrate was prepared with the prepreg prepared in Embodiment 2. Prepreg of 7628 was cut to have a size of 18″×24″, and 8 prepregs were laminated between two copper foils of 1 oz. Then, the Cu-prepreg-Cu structure was placed in two stainless steel plates, and finally the laminated structure was sent into a vacuum laminating machine for further curing, in which thermal energy of at least 190° C./90 min or above was needed for the prepreg to complete the curing reaction. Moreover, a pressure of at least 285-psi needed to be applied (for 90 min) to strengthen the bonding strength between the prepregs and the bonding strength between the prepreg and the copper foil, and the vacuum level in the vacuum laminating machine needed to be maintained at 700 torr or above, to avoid remaining of gas in the prepreg during curing.

Table 2 below shows the electrical, mechanical, and physical properties of the copper foils prepared in Embodiments 1 to 3.

TABLE 2

| Property | Parameter | Method | Composition 1 | Composition 2 | Composition 3 | Composition 4 |
|---|---|---|---|---|---|---|
| Tg | DSC | DCS@10° C./min | 180 | 173 | 185 | 145 |
| | TMA | TMA@10° C./min | 163 | 161 | 166 | 130 |
| Z-CTE | TMA | TMA@10° C./min | 2.9 | 2.8 | 2.9 | 2.9 |

| | | | | | |
|---|---|---|---|---|---|
| T-288 | miniutes to delamination Cu clad | 3.5 | 3.6 | 3.5 | 4.1 |

| | | | | | |
|---|---|---|---|---|---|
| Dielectric Constant | IPC-TM-650 | 4.1 | 4.2 | 4.1 | 4.2 |
| (Dk; 1 MHz; 43% RC; 7628x8Ply) | (HP-4291B) | | | | |
| Dissipation Factor | | 0.006 | 0.008 | 0.007 | 0.009 |
| (Dk; 1 MHz; 43% RC; 7628x8Ply) | | | | | |
| Copper Peel Strength (1 oz) | (lb/in) | 7.8 | 8.2 | 8.0 | 8.0 |

| Flammability | (94-V0) | | V-0 | V-0 | V-0 | V-0 |
|---|---|---|---|---|---|---|
| Property | Parameter | Method | Composition 5 | Composition 6 | Composition 7 | Composition 8 |
| Tg | DSC | DCS@10° C./min | 153 | 160 | 175 | 173 |
| | TMA | TMA@10° C./min | 138 | 143 | 161 | 159 |
| Z-CTE | TMA | TMA@10° C./min | 3.0 | 2.7 | 3.1 | 2.9 |

| | | | | | |
|---|---|---|---|---|---|
| T-288 | miniutes to delamination Cu clad | 3.5 | 4.2 | 3.5 | 3.6 |

| | | | | | |
|---|---|---|---|---|---|
| Dielectric Constant | IPC-TM-650 | 3.9 | 4.0 | 3.9 | 4.0 |
| (Dk; 1 MHz; 43% RC; 7628x8Ply) | (HP-4291B) | | | | |
| Dissipation Factor | | 0.008 | 0.008 | 0.007 | 0.007 |
| (Dk; 1 MHz; 43% RC; 7628x8Ply) | | | | | |
| Copper Peel Strength (1 oz) | (lb/in) | 8.2 | 8.2 | 7.7 | 7.6 |

| Flammability | (94-V0) | | V-0 | V-0 | V-0 | V-0 |
|---|---|---|---|---|---|---|
| | | | | Composition | Composition | Composition |
| Property | Parameter | Method | Composition 9 | 10 | 11 | 12 |
| Tg | DSC | DCS@10° C./min | 180 | 153 | 157 | 164 |
| | TMA | TMA@10° C./min | 163 | 140 | 141 | 148 |
| Z-CTE | TMA | TMA@10° C./min | 3.0 | 3.1 | 3.0 | 2.8 |

| | | | | | |
|---|---|---|---|---|---|
| T-288 | miniutes to delamination Cu clad | 3.5 | 4.1 | 3.9 | 4.2 |

| | | | | | |
|---|---|---|---|---|---|
| Dielectric Constant | IPC-TM-650 | 4.0 | 3.9 | 4.0 | 3.8 |
| (Dk; 1 MHz; 43% RC; 7628x8Ply) | (HP-4291B) | | | | |
| Dissipation Factor | | 0.009 | 0.008 | 0.006 | 0.007 |
| (Dk; 1 MHz; 43% RC; 7628x8Ply) | | | | | |
| Copper Peel Strength (1 oz) | (lb/in) | 7.8 | 8.1 | 7.9 | 8.3 |

| | | | | | |
|---|---|---|---|---|---|
| Flammability | (94-V0) | V-0 | V-0 | V-0 | V-0 |

It can be seen from the results in the table that the thermosetting epoxy resin composition of the present invention has a low dielectric constant, a low dissipation factor (or referred to as low dielectric tangent), and excellent good thermal stability (T-288), and a cured product thereof has excellent flame retardancy (UL-94-V0), and excellent electrical and mechanical properties. Therefore, the thermosetting epoxy resin composition of the present invention may be used in printed circuit laminates, build-up bonding resin, adhesives, and package materials.

While the present invention has been described with reference to the embodiments and technical means thereof, various changes and modifications can be made based on the disclosure or teachings described herein. Any equivalent changes made based on the concepts of the present invention having their effect without departing from the spirit encompassed by the specification and drawings should be construed as falling within the scope of the invention as defined by the appended claims.

According to the aforementioned disclosure, the present invention surely can achieve the expected objectives and provides a thermosetting resin composition, and a prepreg or a laminate using the same, which have industrial applicability. Thus, the application for a patent is filed according to the law.

What is claimed is:

1. A thermosetting resin composition, comprising an epoxy resin and a curing agent, wherein the curing agent is a dual-curing agent system formed with a multi-functional aromatic polyester curing agent in combination with a phenolphthalein benzoxazine phenol aldehyde or a poly(styrene-co-maleic anhydride) (SMA).

2. The thermosetting resin composition according to claim 1, wherein the multi-functional aromatic polyester curing agent is formed by reacting an aromatic polyvalent carboxyl residue having an aryloxycarbonyl group at an end of the molecule chain and an aromatic polyvalent hydroxyl compound, and has an ester equivalent weight (EEW) of 180-500.

3. The thermosetting resin composition according to claim 1, wherein the phenolphthalein benzoxazine phenol aldehyde has a —OH value of 200-700, and a nitrogen content of 4-20 wt %.

4. The thermosetting resin composition according to claim 1, wherein the poly(styrene-co-maleic anhydride) has an acid value of 100-600.

5. The thermosetting resin composition according to claim 1, wherein the epoxy resin is one of a phosphorus-containing epoxy resin, a nitrogen-containing epoxy resin, and a bis-phenol F epoxy resin, or a combination thereof.

6. The thermosetting resin composition according to claim 5, wherein the phosphorus-containing epoxy resin is a modified epoxy resin of DOPO-PNE, DOPO-CNE, or DOPO-HQ, and has a phosphorus content of 2-10 wt %, and an epoxy equivalent weight (EEW) of 250-800.

7. The thermosetting resin composition according to claim 5, wherein the nitrogen-containing epoxy resin is one of a N,N-Diglycidyl epoxy resin, an epoxy resin having an oxazolidone ring, or a polyamide-imide-epoxy (PAI-epoxy) resin, and has a nitrogen content of 5-20 wt %, and an epoxy equivalent weight (EEW) of 100-1000.

8. The thermosetting resin composition according to claim 5, wherein the bis-phenol F epoxy resin has an epoxy equivalent weight (EEW) of 150-1000.

9. The thermosetting resin composition according to claim 1, wherein a curing catalyst is further added.

10. The thermosetting resin composition according to claim 9, comprising 10-90 wt % of the epoxy resin, 90-10 wt % of the dual-curing agent system, and 0.01-5 wt % of the curing catalyst.

11. The thermosetting resin composition according to claim 10, wherein the dual-curing agent system comprises 20-95 wt % of the multi-functional aromatic polyester curing agent and 5-80 wt % of the phenolphthalein benzoxazine phenol aldehyde.

12. The thermosetting resin composition according to claim 10, wherein the dual-curing agent system comprises 20-95 wt % of the multi-functional aromatic polyester curing agent and 5-80 wt % of the poly(styrene-co-maleic anhydride).

13. The thermosetting resin composition according to claim 9, wherein the curing catalyst is one of an imidazole compound, an organophosphorus compound, an organophosphate compound, a phosphate salt, a trialkylamine, 4-(dimethylamino)pyridine, a quaternary ammonium salt, and an urea compound.

14. The thermosetting resin composition according to claim 9, further comprising a solvent for dissolving the thermosetting resin composition into a varnish-like composition.

15. The thermosetting resin composition according to claim 14, wherein the solvent is one of an amide solvent (N-methylpyrrolidone, N-methylformamide, N,N-dimethylformamide, and N,N-dimethylacetamide), a ketone solvent (acetone, methyl ethyl ketone, methyl isobutyl ketone, and cyclohexanone), an ether solvent, an aromatic hydrocarbon solvent, and a glycol monoether.

16. The thermosetting resin composition according to claim 14, wherein inorganic filler is further added, and the inorganic filler accounts for 1 to 30 wt % of the composition, and is one of aluminum hydroxide, aluminium oxide hydroxide, magnesium hydroxide, silica, and spherical and crushed alumina.

17. The thermosetting resin composition according to claim 16, wherein the inorganic filler has an average particle size in a range of 0.01 μm to 20 μm.

18. The thermosetting resin composition according to claim 14, wherein a high thermal conductive inorganic filler is further added, and the high thermal conductive inorganic filler accounts for 10 to 80 wt % of the composition, and is one of hexagonal and spherical aluminum nitride, hexagonal and spherical boron nitride, spherical alumina, crushed alumina, silicon carbide, and graphite.

19. The thermosetting resin composition according to claim 18, wherein the silicon carbide comprises hexagonal αsilicon carbide and cubic β-silicon carbide.

20. The thermosetting resin composition according to claim 18, wherein the high thermal conductive inorganic filler has an average particle size in a range of 0.01 μm to 20 μm.

21. A prepreg, being a reinforced material impregnated with a thermosetting resin composition, wherein the thermosetting resin composition comprises an epoxy resin and a curing agent, the curing agent is a dual-curing agent system formed with a multi-functional aromatic polyester curing agent in combination with a phenolphthalein benzoxazine phenol aldehyde or a poly(styrene-co-maleic anhydride).

22. The prepreg according to claim 21, wherein the reinforced material is an organic or inorganic woven or non-woven fiber reinforced material.

23. A laminate, comprising:
a substrate, comprising a thermosetting resin composition, wherein the thermosetting resin composition comprises an epoxy resin and a curing agent, the curing agent is a dual-curing agent system formed with a multi-functional aromatic polyester curing agent in combination with a phenolphthalein benzoxazine phenol aldehyde or a poly(styrene-co-maleic anhydride); and
at least one metal foil, for being bonded on a surface of the substrate.

24. The laminate according to claim 23, wherein the substrate is formed with an organic or inorganic woven or non-woven fiber reinforced material, and is impregnated with the thermosetting resin composition thereon.
